(19) United States
(12) Patent Application Publication
(10) Pub. No.: US 2007/0055954 A1
(43) Pub. Date: Mar. 8, 2007

(54) System and method for development and architecture of an expert system and corresponding user interface

(76) Inventor: David Long, Ottawa (CA)

Correspondence Address: SPRINKLE IP LAW GROUP, 1301 W. 25TH STREET, SUITE 408, AUSTIN, TX, 78705, US

(21) Appl. No.: 11/221,017

(22) Filed: Sep. 7, 2005

(51) Int. Cl. G06F 9/44

(52) U.S. Cl. 717/104; 717/136

(57) ABSTRACT

Systems and methods for automated development of a software application for implementing a process are disclosed. After obtaining a set of specifications or knowledge from a customer or potential end user about the operation of a software application these systems and methods may allow this knowledge or specifications to be represented in a modeling language. From this model one or more finite state machines may be generated and one or more of these finite state machines can in turn be used to generate a user interface for interacting with the finite state machines.

### TECHNICAL FIELD OF THE INVENTION

This invention relates generally to expert systems, and more particularly, to the development, architecture and interfaces of rapidly deployable process control systems.

### BACKGROUND OF THE INVENTION

In recent years the size and complexity of software applications has grown markedly. Commensurate with the growth of software applications, the development cycle of these software applications has also grown. As a result of this there are usually a large number of people involved in the development of any one software application. In some cases a customer or end user may have particularly expert knowledge with respect to one or more processes or areas, and wish to translate this expert knowledge into a software application for the automation or implementation of this process or area.

In a typical software development process, the customer or end user may communicate this expert knowledge with respect to the behavior, operation or interface of the software application; architects, designers and systems analysts may be responsible for translating these desires, specifications or knowledge into an over-arching architecture for the software application and its interface while developers or programmers may be responsible for actually implementing these designs to create a functional software application and user interface. A feedback cycle may then ensue, with the application being presented to a customer or group of end users for evaluation. This evaluation process may result in desired changes, which in turn, may result in another cycle of the development process for the software application.

Consequently, these software development processes are prone to inaccuracies and delays as a result of a myriad number of factors such as: problems in translating the customer's desires, knowledge or requirements into a system design or architecture, trouble developing a system which meets the desires or requirements of the customers, or human factors as simple as the customer, end user or developer changing his or her mind about the way the interface to the system should look, feel or operate.

To address these delays a variety of automated approaches have been developed to assist in the life cycle of the software development process. Typically, these automated approaches allow a software system or application to be modeled, for example with a modeling language such as universal modeling language (UML). From these models a set of class definitions in an object oriented language such as C++ or Java may be created. These class definitions may be the classes needed to implement the software application and an interface for the software application.

The software classes generated by these automated approaches are, however, typically stub functions only.

The actual coding of the software application must still be accomplished. Additionally, a user interface must be developed for the software application which will allow operation of the software application. Thus, while these automated approaches provide a framework for the development of a software application these automated approaches do not actually generate a complete and functional software application and user interface. As these methodologies still require a significant amount of human intervention in order to generate a functioning software application and user interface the problems discussed above with respect to human factors cannot be completely ameliorated.

Thus, it is desired to be able to capture expert knowledge and utilize this expert knowledge to generate a complete, functional software application and user interface in an automated fashion.

### SUMMARY OF THE INVENTION

Systems and methods for automated development of a software application for implementing a process are disclosed. After obtaining a set of specifications or knowledge from a customer or potential end user about the operation of a software application these systems and methods may allow this knowledge or specifications to be represented in a modeling language. From this model one or more finite state machines may be generated and one or more of these finite state machines can in turn be used to generate a user interface for interacting with the finite state machines.

In one embodiment, a model capturing some aspect of human knowledge in a modeling language is generated. A software system can be generated from this model. This software system includes a user interface. Interaction with the user interface may cause events to be generated and the software system may process these generated events.

In another embodiment, the first software system comprises a controller including a finite state machine.

In other embodiments, the user interface may be updated when an event is processed by the software system.

In yet other embodiments, a software system is generated from the model at a server. An event can be sent from a software system on a client to the server. The server may then send this event to a software system on another client.

Embodiments of the present invention provide the technical advantage that a specific modeling language may have the ability to accurately model a given set of human knowledge. This modeling language may be used to represent many varieties of processes and knowledge.

Similarly, another technical advantage is that a complete and functioning software system may be generated from a model without requiring human intervention. Part and parcel with this, a user interface associated with the software system may be automatically generated as well. This user interface may be used to drive the software system.

The ability to automatically generate a software system and associated user interface may shorten the time required to develop and deploy a particular software system or application. Additionally, as the software system is generated automatically the resulting software system may be more fault tolerant, making it more resistant to unpredictable engineering factors.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein identical reference numerals designate the same components. The invention may be better understood by reference to one or more of these drawings in combination with the description presented herein. It should be noted that the features illustrated in the drawings are not necessarily drawn to scale.

FIG. 1 is a block diagram of an exemplary network architecture.

FIG. 2-4 is a flow diagram of one embodiment of the present invention.

FIG. 5 is an illustration of one embodiment of an interface which may be utilized in conjunction with the construction of a model.

FIGS. 6A and 6B are illustrations of one embodiment of a set of classes for use in the generation of a finite state machine for the implementation of a process.

FIG. 7 is an illustration of one embodiment of an interface which may be utilized in conjunction with the use of a model on a server; and

FIG. 8 is an illustration of one embodiment of an interface which may be generated by a process and utilized by a user to interact with the process.

### DETAILED DESCRIPTION

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

A few terms are defined or clarified to aid in understanding the descriptions that follow.

The term process will be used to refer to any type of human knowledge which it may be desired to model as a software system. The term process will also be used to refer to a model created from this human knowledge or an instantiated object or set of objects that are operable to be used in conjunction with, or to implement, a software system or finite state machine to implement such a process.

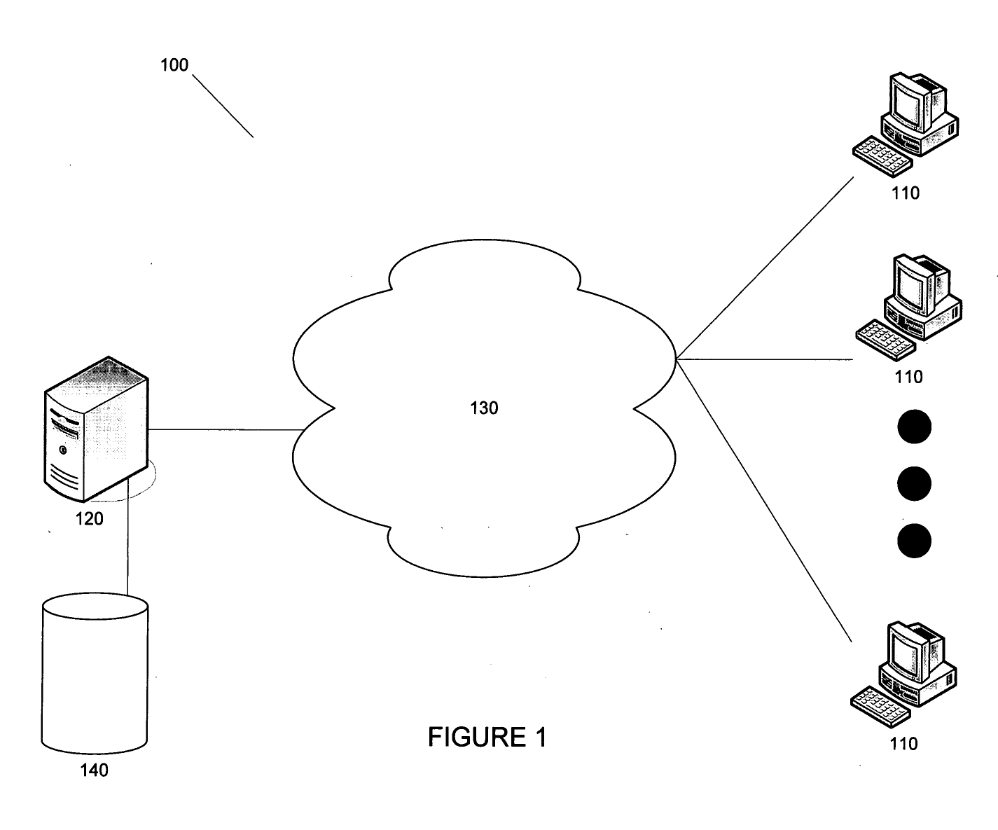

Before describing the systems and methods of the present invention it may be useful to describe an exemplary architecture which will be used herein to assist in describing embodiments of these systems and methods. Turning to FIG. 1, an exemplary architecture for a client-server system is depicted. System 100 includes at least one client computer 110 and at least one server computer 120. Client computers 110 can connect to, or communicate with, server 120 via network 130. Network 130 can comprise any global computer network (e.g. the Internet), a wireless network, a local area network, or any other network capable of transporting data between computing devices. Client computers 110 and server computer 120 can be a personal computer, workstation, a wireless device, a laptop computer, or any other computer operable to execute computing instructions. Client computer 110 and server computer 120 can include a central processing unit and computer readable memory, which may be any combination of RAM, ROM, magnetic storage device, such as a hard drive, and/or other computer readable medium. For example, in one embodiment, server computer 120 may be coupled to, and operable to send and receive data from, database 140 which may be an ORACLE database, a db2 database, another type of database which is responsive to SQL queries, or any other type of database known in the art.

Though the embodiments of the systems and methods of the present invention described below may be described in conjunction with the exemplary client-server system 100 described with respect to FIG. 1, those skilled in the art will appreciate that these same systems and methods may be utilized in conjunction with other system architectures and/or computing systems and the architecture of the systems with which embodiments of the present invention may be employed can be selected based on the particular implementation desired or goals to be accomplished.

Attention is now directed to systems and methods for automated development of a software application for implementing a process. After obtaining a set of specifications or knowledge from a customer or potential end user about the operation of a software application these systems and methods may allow this knowledge or specifications to be represented in a modeling language. From this model one or more finite state machines may be generated and one or more of these finite state machines can in turn be used to generate a user interface for interacting with the finite state machines.

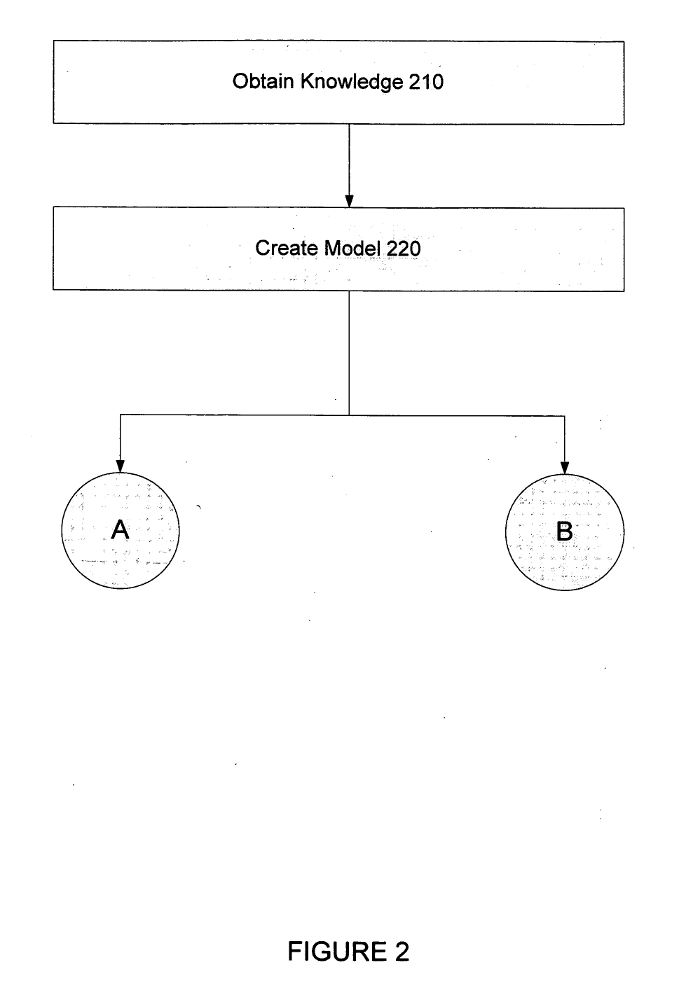

FIGS. 2-4 are a flow diagram for one embodiment of the systems and methods of the present invention. At step 210 a set of specifications, semantics or knowledge may be obtained. This set of specifications, semantics or knowledge can then be represented in a model using a modeling language at step 220. This model can then be provided to a server. The server may generate a controller from this process at step 310. This controller may in turn obtain an event at step 320, evaluate whether the event should be processed at step 330 and process the event at step 340. When a client connects to the server the client may obtain a model from which the controller currently being utilized by the server was created at step 410, and generate a controller from this model at step 420. This controller may itself generate a user interface at step 430 through which a user may interact. Interaction with this user interface may generate event which are placed in an event queue. Events may be obtained from the event queue at step 440, a determination made whether the event should be processed at step 450, and if so, the event may be processed at step 460.

Suppose a person or a group of people have a workflow or process and wish to develop a software application to automate such a workflow or process. Returning to FIG. 2, this knowledge or process may be obtained at step 210. This may entail a description of workflow, process, interactions, specifications or any other data that related to any aspect of human knowledge that is desired to be capture in a natural language.

This natural language description may then be represented in a modeling language at step 220. This modeling language may be abstract enough to reflect the semantics that may be expressed in natural language. In particular, this modeling language may be capable of representing an event driven system by representing the data of the event driven system, the states of the event driven system and how the event driven system changes states. The language may be a precursor to a software system and reflect the capabilities within a software system which may result from a model written in the modeling language. Additionally, the language may be recursively defined.

In one embodiment, this language comprises representation for the following pieces:

Element—An element is a single unit or atom of data within the system. An element may not be broken down any further in the context of the process without loss of meaning.

State—A state is a part of a process that contains activities. A state may be a condition of the process at any one moment in time. A system or process can be in one state at a given time.

Group—A group is a unit of work that may be generated in a given state in a process. A group has a collection of elements, is also a type of element and may, in a software system resulting from the model, have the capability to represent itself.

Activity—An activity is a task that is performed when the process is in a given state.

Transition—A transition is a relationship between two states, a start state and an end state. A transition is a path along which data can be transferred. A transition may have an associated event which is used to determine when the end state should become active. A transition can have an Action that runs when the end state becomes active.

Event—An event is a temporal occurrence that asserts itself when a set of conditions becomes true.

Action—An action is a method or function that happens when a transition has made its associated end state become active.

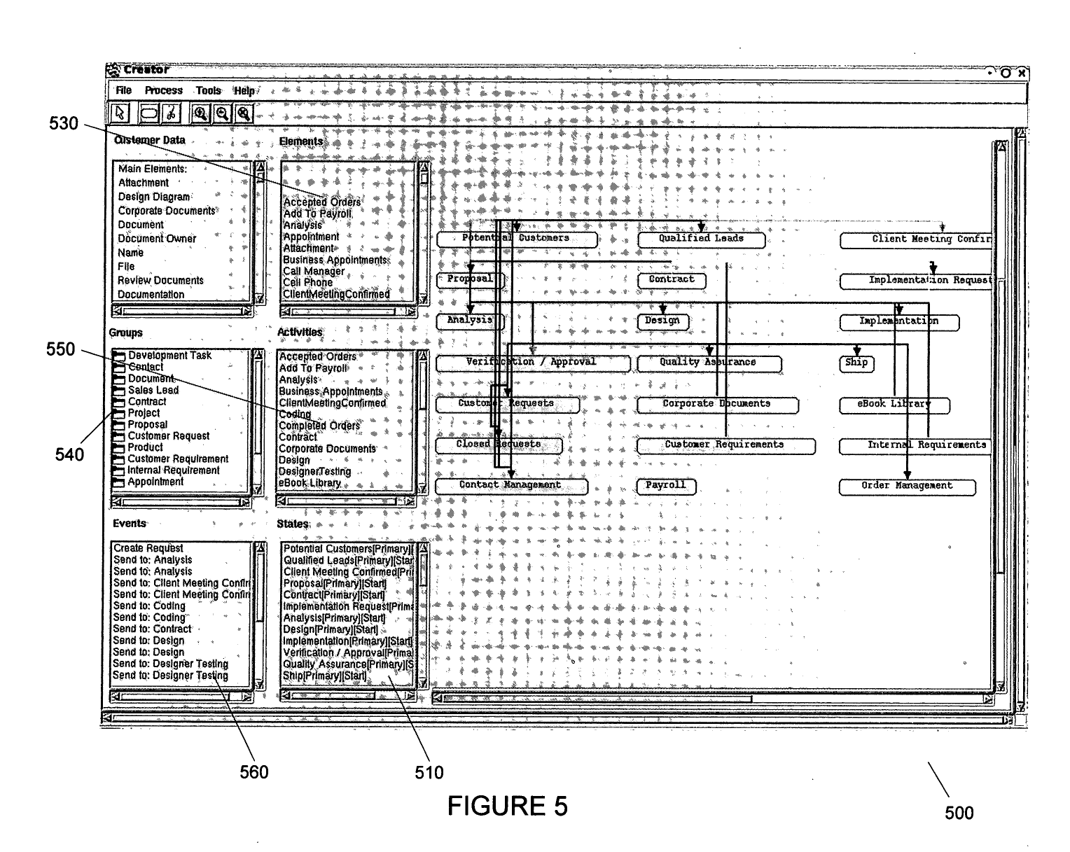

In one embodiment, a software application may be utilized at step 220 to generate a model in the modeling language. FIG. 5 depicts one embodiment of an interface for just such an application. Interface 500 may allow a person interacting with interface 500 to define a set of states 510 and associate these states 510 with data 520, elements 530, groups 540, activities 550 or events 560. In one particular embodiment, interface 500 accepts normal text descriptions and allows a user of interface 500 to filter this text into elements 530 using menu options of interface 500. States 510, data 520, elements 530, groups 540, activities 550 or events 560 may also be represented graphically during interaction with interface 500. After a user has finished modeling a process utilizing interface 500 a model of this process in the modeling language may be created and saved in a file. This file may contain, in addition to the model, a class definition of a controller which may be utilized to implement a finite state machine based on the model included in the file. In one embodiment, saving this model may also result in the creation of a set of tables and data in database 140. This set of tables and data may be for use with software applications created from this model.

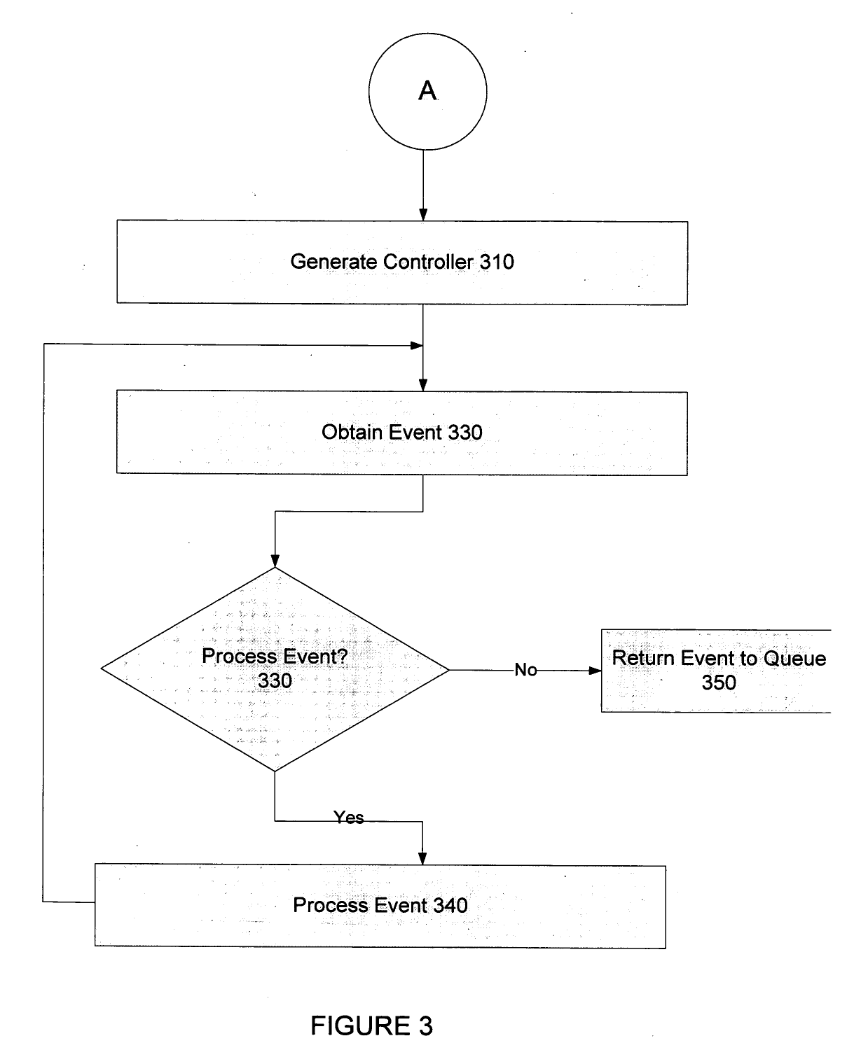

Once the desired process is represented in a model represented in an embodiment of the modeling language at step 220, this model may be used to generate a finite state machine. FIG. 3 is a flow diagram of one embodiment of the generation and use of a finite state machine from a model by server 120. At step 310 software executing on server 120 may create a controller. In one embodiment, a Smalltalk virtual machine may interact with the controller on server 120 causing the standard method of Smalltalk to be executed. This standard method may be given the definition of the controller class contained in the model and instantiate a controller from this controller class definition. In one embodiment, this controller class may be a subclass of the SFAbstract Controller class (described below).

Once a controller is instantiated at step 310, this controller may, in turn, instantiate a set of software objects which will enable the controller to implement a finite state machine operable to implement the process for which the model was generated. In one embodiment, a set of classes may be used to generate the software objects for the finite state machine and these software objects may be associated with the controller object.

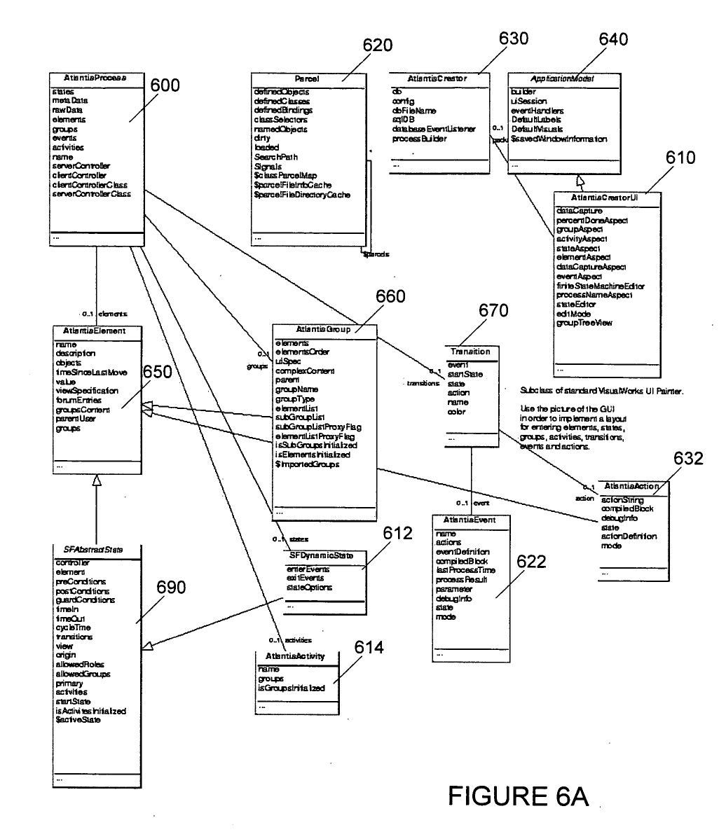

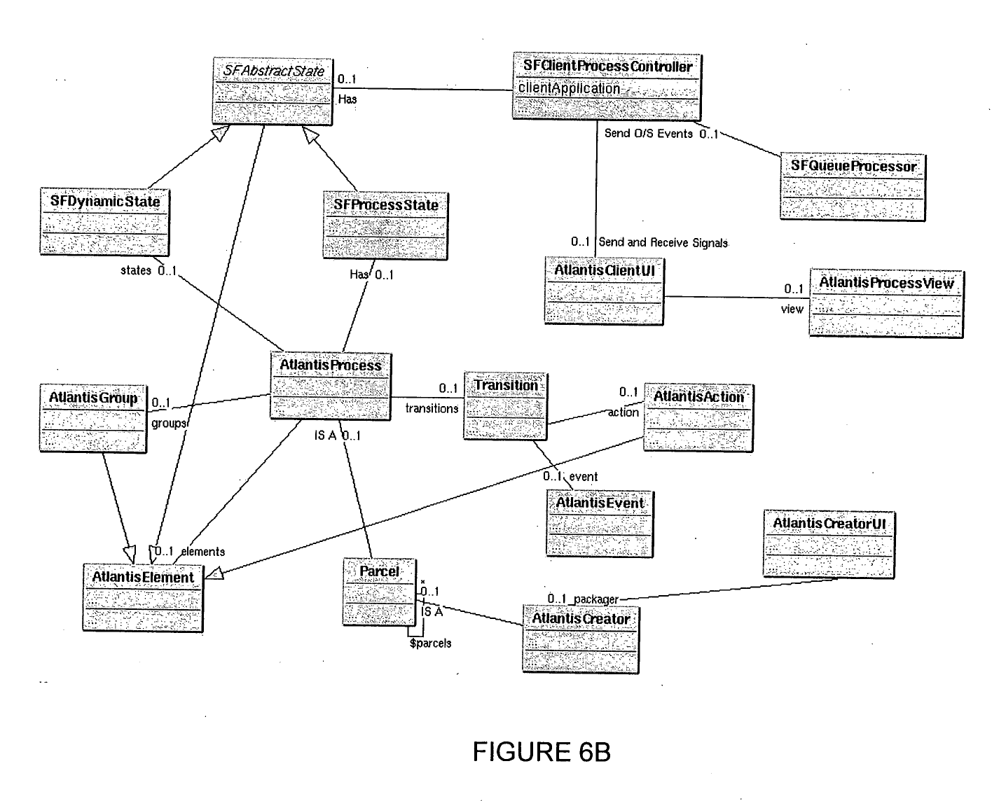

FIGS. 6A and 6B depict a representation of one embodiment of just such a set of classes. These classes may be in Smalltalk, Java or any other software programming language that supports class definitions. AtlantisProcess class 600 implements a single instance of a process. An instance of an AtlantisProcess class 600 may be a persistent object that is stored in a VisualWorks Parcel file. This may happen when the data in an instance of AtlantisCreatorUI class 610 is saved. AtlantisProcess class 600 may have the following instance variable: states, metadata, rawData, elements, groups, events, activities, name, serverController, clientController, clientControllerClass and serverControllerClass.

Parcel class 620 is a class from which an object may be instantiated where that object is able to store and load itself and can contain a set of other objects. A parcel object may be used to contain a single instance of an AtlantisProcess object. Parcel class 620 may be a standard Visual Works Smalltalk base class.

AtlantisCreator class 630 is the model class used to contain the data and respond to user actions in instance of AtlantisCreatorUI class 610. When an AtlantisCreatorUI object is launched or instantiated, it creates an instance of the AtlantisCreator class 630. As a user begins to interact with the an interface for the process, an AtlantisCreator object may be notified using standard VisualWorks user interface architecture (menu driven messages to objects). An AtlantisCreator object may have an AtlantisProcess object stored as an instance variable known as ‘db’. The process is populated with data and eventually notified to store itself using a Parcel object. The AtlantisCreator class 630 may have the following instance variables: db, dbFileName and processBuilder.

The ApplicationModel class 640 may be a standard Visual Works base class meant for standard user interface design. The ApplicationModel class 640 may provide the standard user interface framework for an object of AtlantisCreator class 630.

The AtlantisElement class 650 may be used to instantiate an object to represent an Element in a process.

AtlantisElement 650 may have the following instance variables: name, description, timeSinceLastMove, value, viewSpecification, groupsContent, parentUser and groups.

The AtlantisGroup class 660 may be used to instantiate an object which represents a group in a process. The AtlantisGroup class 660 may have the following instance variables: elements, elementsOrder, uiSpec, complexContent, parent, groupName, groupType, elementList, subGroupList, subGroupListProxyFlag, elementListProxyFlag, isSubGroupsInitialized and isElementsInitialized.

The Transition class 670 can be used to instantiate an object which represents a transition in a process. An object instantiated from Transition class 670 allows a process to change state. An object instantiated from Transition class 670 may be associated with its start and end states. When running, the state machine controller constantly checks the active state to see if an object instantiated from Transitions class 670 has been activated. If such an object has activated then the state machine will alter its currently active state. If an object instantiated from Transition class 670 has an action set then the action will run its associated method if the object is activated. The Transition class 670 may have the following instance variables: event, startState, endState, action name and color.

An object instantiated from the AtlantisCreatorUI class 610 provides the ability for a user to load, edit and save a process. The AtlantisCreatorUI class 610 may include the following instance variables: dataCaptureAspect, groupAspect, activityAspect, stateAspect, elementAspect, finiteStateMachineEditor, groupTreeView and packager.

The SFAbstractState class 690 implements basic behaviour for states in a finite state machine generated from a process. SFAbstractState class 690 may be an abstract class which gives subclasses a standard for adding new subclasses (different types of states) to the system. States can be either system states (SFProcessState) or business states (SFDynamicState). SFAbstractState class 590 may have the following instance variables: preconditions, postConditions, guardConditions, timeIn, timeout, transitions activities, allowedGroups, allowedRoles, primary and activeState.

The SFProcessState class (not shown) may implement basic behaviour for system states in a finite state machine generated from a process. System states are Smalltalk classes and are part of the object hierarchy for a given process. If new system states are added in an Atlantis CreatorUI object, an AtlantisCreator object will add those classes directly to the object hierarchy for that process. This creates the ability to dynamically program the system without needing any programming skills. The AtlantisCreatorUI object will automatically generate the required code based on a user's choice of icons in the representation of the AtlantisCreatorUI object. System states are meant to interact with the operating system.

SFProcessState class may have the following instance variables: preferredLocation.

The class SFDynamicState 612 may allow an object instantiated from the class to represent a business state in a process. A business state is stored as data only in the process definition. A business state may contain only enough information to display itself on a screen and be a state in a process. A business state may interact with an operating system and be used by objects instantiated by a AtlantisCreatorUI object to model high level business activities.

The class AtlantisActivity 614 allows objects to be instantiated which represent an activity in the process.

An instance of AtlantisActivity class 614 may be contained by an instance of a state. An instance of AtlantisActivity class 614 may contain a collection of groups. When a finite state machine is running, the instance of AtlantisActivity class 614 generates new instances of groups in response to user actions. Users of the system can transfer groups from one activity to another. AtlantisActivity class 614 may have the following instance variables: name, groups, isGroupsInitialized.

The AtlantisEvent class 622 represents an event in a process. An object instantiated from AtlantisEvent class 622 may contain a method or function which returns true or false when called. The method can take an optional object or collection of objects as parameters. If the method or function returns true then the event can be considered to have happened. In one embodiment, objects instantiated from AtlantisEvent class 622 use the standard exception handler of the language in which they are written to trap any errors that occur when that object's method is called. These exceptions may become events themselves and are sent to the finite state machine controller for further processing. AtlantisEvent class 622 may have the following instance variables: name, actions, eventDefinition, compiledBlock, lastProcessTime, processResult, parameter, debugInfo and state mode.

Objects instantiated from the AtlantisAction class 632 can represent an action in a process. An object instantiated from AtlantisAction class 632 may be associated with a transition and contains a function definition that is called when a transition fires. This function may be a Smalltalk method. An object instantiated from AtlantisAction class 632 may use the standard exception handler of the language in which AtlantisAction class 632 is written to trap any errors that occur when an event method is called. These exceptions become events themselves and are sent to the finite state machine controller for further processing. AtlantisAction class 632 may have the following instance variables: compiledBlock, state, actionDefinition and mode.

An object instantiated from SFAbstractController class (not shown) may provide a framework for a controller hierarchy. In one embodiment, a process has two controllers, one for the client and one for the server. A controller is a class, and as such can inherit behaviour from other controllers in the hierarchy. The method (function) definitions used by AtlantisEvent objects and AtlantisAction objects may be methods in the controller classes. When the finite state machine controller changes states, it causes methods in the controller to be called. The controller has a queueProcessor which accepts objects added to its queue by the operating system and other actors in the Smalltalk virtual machine. The controller has a context, which may be an object that it controls. The context can be any object in the object hierarchy, and is typically a domain specific manager designed to interact with a third party API. SFAbstractController class may have the following instance variables: context, queueProcessor, states, userData, initializingState, activeState, currentEvent and lastError.

Returning to FIG. 3, once the controller has instantiated the set of software objects, the controller may in turn obtain an event at step 320 and determine if the event should be processed at step 330. In one embodiment, the controller may have a queue in which events which occur in association with the server may be contained. The controller may have a currently active state which is one of the set of states in the set of software objects generated by the controller. Initially, the controller may be in an initial or idle state or have an initial or idle state as the currently active state. When an event is created the event may be entered in the event queue. The controller may obtain an event from the event queue and determine if the event is related to the currently active state by determining if the event is associated with any of the transition objects of the process which have the currently active state as their start state. If the event is associated with a start state for a transition associated with the currently active state (YES branch) the processing of this event at step 340 may result in the evaluation of the transition and of the actions associated with the transition, including the execution of the methods associated with these actions. Processing of the event may also include communicating the event to one or more of client computers 110. The evaluation of this transition may result in the controller having a newly active state, after which another event can be obtained from the event queue at step 320.

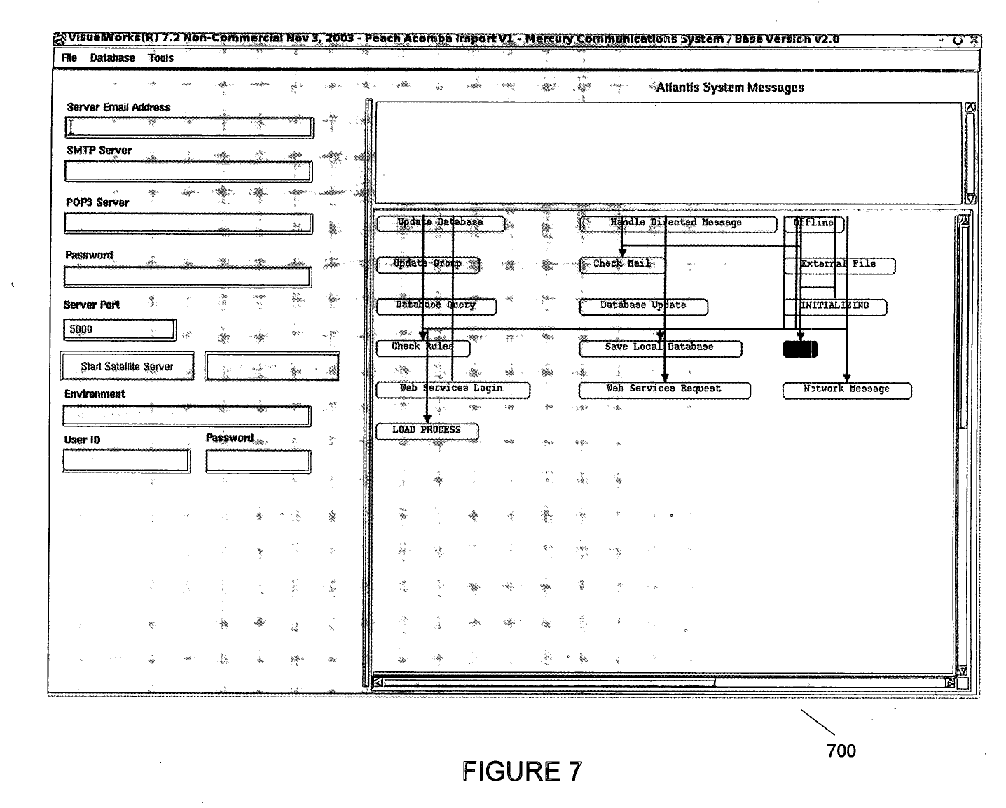

If, on the other hand, the event obtained at step 320 is not associated with the currently active state (NO branch of step 330), this event may be placed back in the event queue for later processing at step 350. FIG. 7 depict one embodiment of an interface for use with a controller executing on server 120. Interface 700 may display the possible states of the controller and the current state of the controller.

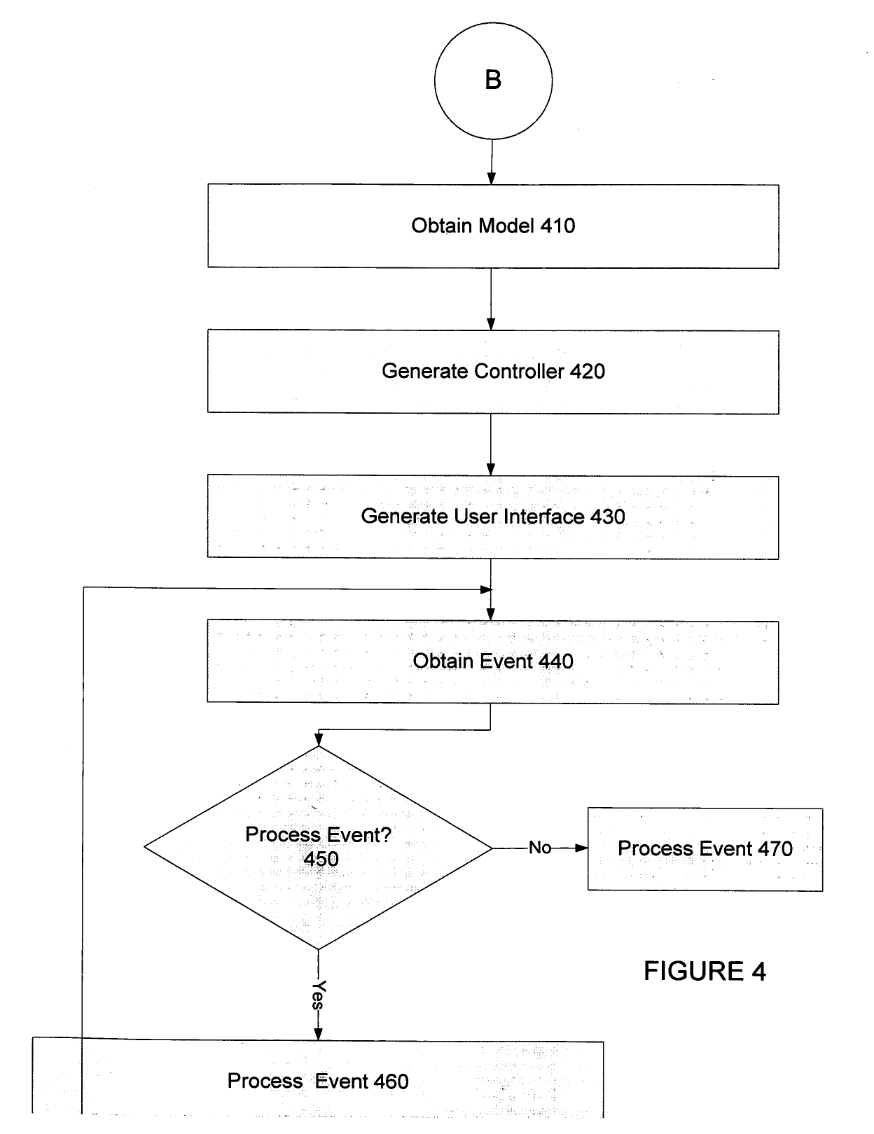

Similarly, a client computer 110 may also utilize a model to create a controller and an associated user interface. FIG. 4 is a flow diagram of one embodiment of the use of a process model by a client 110. Client 110 may connect with server 120 to obtain a model at step 410. In one embodiment, client 110 may obtain the model that was utilized to generate the controller currently executing on server 120 using Common Object Request Broker Architecture (CORBA).

At step 420 client 110 may create a controller. In one embodiment, this controller may be instantiated from the definition of a controller class contained in the model obtained at step 410. In one embodiment, this controller class may be the SFAbstract Controller class.

Once a controller is instantiated at step 420, this controller may instantiate a set of software objects will enable the controller to implement a finite state machine operable to implement the process for which the model was generated. In one embodiment, a set of classes may be used to generate the software objects for the finite state machine. This set of classes may be the same set of classes utilized by the controller on server 110 in generating a set of objects.

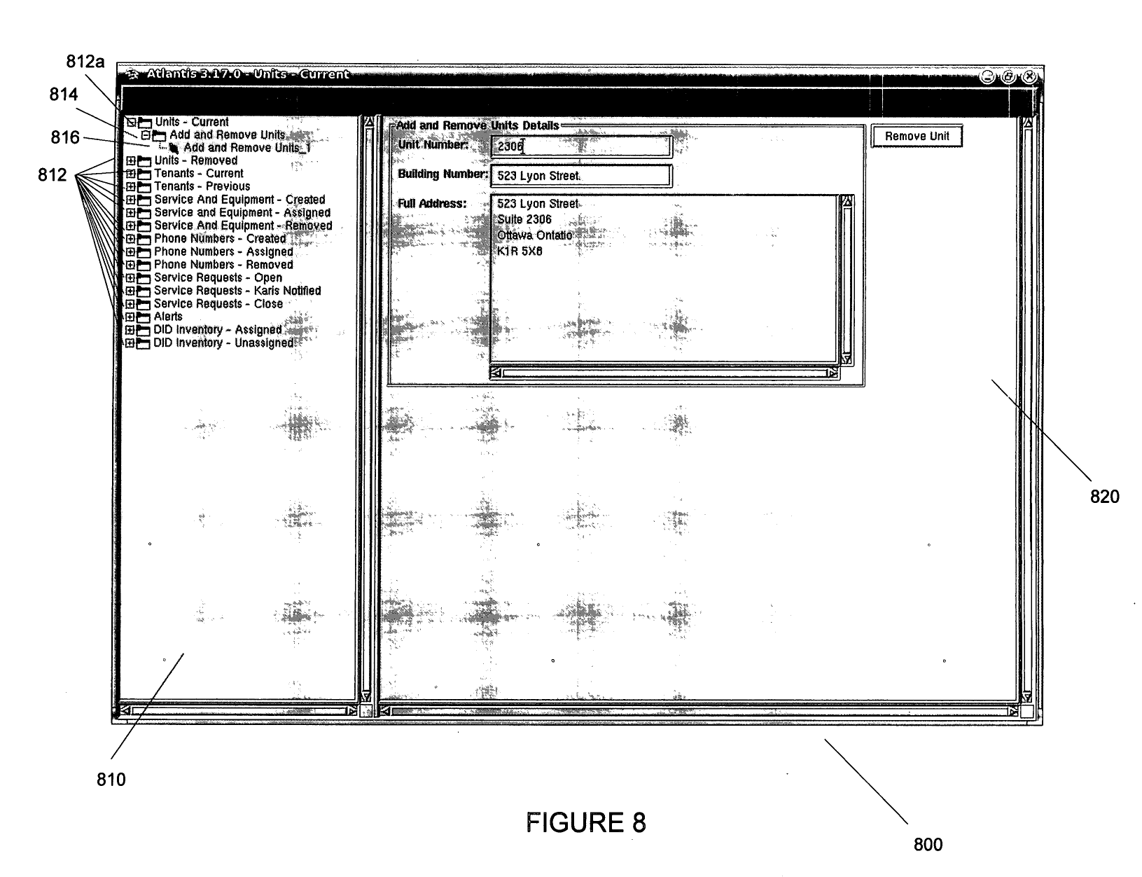

Once this set of objects is generated, a user interface may be generated by the controller on client 110 based on the current state of the controller at step 430. One embodiment of such a user interface is depicted in FIG. 8. In one embodiment, a controller may draw user interface 800 by instantiating an object of AtlantisCreatorUI class 610.

User interface 800 may be generated based on the model and the currently active state of the finite state machine implementing the process for which the model was created. User interface 800 may have one area 810 which may be utilized for navigation and a second area 820 which may be utilized for manipulation of data.

Navigation area 810 may present the process implemented by the controller as a set of folders 812. Each of folders 812 may indicate a possible state of the process. In particular, one folder 812a, which is representative of the current state of the finite state machine implementing the process may be expanded. Each subfolder 814 under the folder 812a which represents the current state may represent an activity which can be performed in the current state. Under each of these subfolders 814 representing the activities that may be performed in a state are groups 816 on which the activities may be performed, or which the activity has generated. Functionally, the user interface may contain visual parts that represent the concepts or underlying objects of states, activities and groups. However, as will be realized, the visual representations and the locations of the representations may be widely varied.

When a group 816 is selected by a user this group 816 may be drawn in the second area 820 of interface 800. Navigation area 820 may allow a selected group to be moved between activities within the current or other states, or to be moved from one activity to another activity. Thus, user interface 800 may be generated and updated based on the current state of the finite state machine and additionally, interaction with the finite state machine may be accomplished using such a user interface 800.

If a user chooses to move a selected group within the current or other states, or to move from one activity to another activity user interface 800 may generate an event associated with this action may be generated and placed in the event queue of the controller on client 110. Additionally, such an event may be sent to server 120 and placed in the event queue of the controller executing on server 120.

Returning to FIG. 4, the controller on client 110 may obtain one of these events from its events queue at step 440 and determine if the event should be processed at step 450. Events in the event queue may be the result of a user interaction with user interface 800, or may have been communicated from the controller on server 120. Similar to the controller described with respect to server 120 in FIG. 3, in one embodiment the controller executing on client 110 may have a currently active state which is one of the set of states in the set of software objects generated by the controller. The controller may determine if the event obtained from the event queue is related to the currently active state by determining if the event is associated with any of the transition objects of the process which have the currently active state as their start state. If the event is associated with a start state for a transition associated with the currently active state (YES branch) the processing of this event may result at step 460 in the evaluation of the transition and of the actions associated with the transition, including the execution of the methods associated with these actions. The evaluation of this transition may result in the controller having a newly active state, after which the user interface can be generated or updated based on the newly active state and another event can be obtained from the event queue at step 440.

If, on the other hand, the event obtained at step 440 is not associated with the currently active state (NO branch of step 450), this event may be placed back in the event queue for later processing at step 470.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method for generating a software system, comprising
generating a model, wherein the model is defined in a modeling language; and
generating a first software system from the model, wherein the software system includes a user interface and the first software system is operable to receive an event generated from an interaction with the user interface and process the event.

2. The method of claim 1, wherein an interaction with the user interface comprises associating a group with an activity.

3. The method of claim 1, wherein the first software system comprises a controller including a finite state machine.

4. The method of claim 3, wherein the controller has a current state and the controller processes the event if the current state has a transition associated with the event.

5. The method of claim 4, further comprising executing an action associated with the transition if the current state has a transition associated with the event.

6. The method of claim 5, further comprising updating the user interface.

7. The method of claim 6, further comprising:
generating a second software system from the model at a server; and
obtaining the model from the server at the first client, wherein the first software system is generated at the first client.

8. The method of claim 7, further comprising:
sending an event from the first client to the server; and
sending the event from the server to a second client.

9. The method of claim 8, wherein the modeling language includes a representation for an element, a representation for a state, a representation for a group, a representation for a activity, a representation for transition, a representation for an event and a representation for an action.

10. A computer readable medium comprising computer executable instructions for generating a software system, the instructions translatable for:
generating a model, wherein the model is defined in a modeling language; and
generating a first software system from the model, wherein the software system includes a user interface and the first software system is operable to receive an event generated from an interaction with the user interface and process the event.

11. The computer readable medium of claim 10, wherein an interaction with the user interface comprises associating a group with an activity.

12. The computer readable medium of claim 10, wherein the first software system comprises a controller including a finite state machine.

13. The computer readable medium of claim 12, wherein the controller has a current state and the controller processes the event if the current state has a transition associated with the event.

14. The computer readable medium of claim 13, the instructions further translatable for executing an action associated with the transition if the current state has a transition associated with the event.

15. The computer readable medium of claim 14, the instructions further translatable for updating the user interface.

16. The computer readable medium of claim 15, the instructions further translatable for:
generating a second software system from the model at a server; and
obtaining the model from the server at the first client, wherein the first software system is generated at the first client.

17. The computer readable medium of claim 16, the instructions further translatable for:
sending an event from the first client to the server; and
sending the event from the server to a second client.

18. The computer readable medium of claim 17, wherein the modeling language includes a representation for an element, a representation for a state, a representation for a group, a representation for a activity, a representation for transition, a representation for an event and a representation for an action.

19. A method for generating a networked software system for implementing a process, comprising:
generating a model at a server, wherein the model is defined in a modeling language;
generating a first software system from the model at a server;
obtaining the model from the server at a first client;
generating a second software system from the model at the first client, wherein the second software system includes a user interface and the second software system is operable to receive an event generated from an interaction with the user interface process the event and send the event to the first software system; and
wherein the first software system is operable to send the event to a second client.
